(19) United States
(12) Patent Application Publication
(10) Pub. No.: US 2009/0164610 A1
(43) Pub. Date: Jun. 25, 2009

(54) METHOD, GATEWAY, CLIENT, SOFTWARE ARRANGEMENT AND COMPUTER-ACCESSIBLE MEDIUM FOR FACILITATING A HANDOVER BETWEEN A WIRELESS LAN AND A RADIO ACCESS NETWORK

(75) Inventors: Mattias Lampe, Beijing (CN); Zhen Ping Hu, Beijing (CN); Xinglin Wang, Beijing (CN); Ji Feng Tian, Beijing (CN); Jie Zhang, Beijing (CN); Xue Gang Huang, Beijing (CN)

Correspondence Address: DORSEY & WHITNEY LLP;INTELLECTUAL PROPERTY DEPARTMENT, 250 PARK AVENUE, NEW YORK, NY, 10177, US

(73) Assignee: Nokia Siemens Networks Oy, Espoo (FI)

(21) Appl. No.: 12/338,180

(22) Filed: Dec. 18, 2008

Related U.S. Application Data
(60) Provisional application No. 61/016,122, filed on Dec. 21, 2007.

(51) Int. Cl. G06F 15/177

(52) U.S. Cl. 709/221

(57) ABSTRACT

Exemplary embodiments of method, gateway, client, software arrangement and computer-accessible medium are provided for a handover of a client from a local network to an access network. For example, information can be received from the client regarding the client's ability to connect directly to the access network, whereas the client is connected to a local network. A request for the handover of the client and an identification information of the client can be transmitted to the access network. Further, the handover of the client can be initiated from the local network to the access network.

### RELATED APPLICATIONS

This application claims priority from U.S. Provisional Patent Application No. 61/016,122 filed Dec. 21, 2007, the entire disclosure of which is hereby incorporated herein by reference.

### FIELD OF THE INVENTION

The present invention relates to exemplary embodiments of a method for handover of a client from a local network to an access network, to a gateway, which gateway may be arranged between a local network and an access network to support a handover of a client from the local network to the access network, and a user equipment for handover of a client from a local network to an access network.

### BACKGROUND INFORMATION

A Home Node HN generally acts as a gateway between two different networks. From the Access Network's AN point of view the characteristics of the Local Area Network LAN are hidden whereas the clients of the Home Node may be completely unaware of the Access Network and normally have no information about its status.

There may be various situations where it is desirable to enforce the handoff of a client from the Home Node to the Access Network, i.e. a transition from the indirect communication to the access network (through the Home Node) to a direct connection to a base station of the access network.

Handover between different base stations of the same network or different networks of the same type is a common problem and many solutions exist. The handover can be initiated either by the base station or by the client, depending on the communication standard.

### SUMMARY OF EXEMPLARY EMBODIMENTS OF THE INVENTION

There may be a need to provide a method, a corresponding gateway and a corresponding user equipment, which allow a handover between a local network and an access network.

Exemplary embodiments of the present invention provide a methodology for achieving such handoff in a favourable way.

According to an exemplary embodiment of the present invention, a method can be provided for a handover of a client from a local network to an access network. This exemplary method comprises a receipt, from the client, certain information about the client's ability to connect directly to the access network, which client being connected to a local network. A request for handover of the client and an identification information of the client to the access network can be transmitted, and a handover of the client from the local network to the access network can be initiated by the gateway.

Thus, it is possible to handover a client from for example a home network like W-LAN or a LAN to for example a public network, like e.g. a cellular mobile network (such as GSM, UMTS, 2G LTE) or an other access network (such as WiMax or WiBro networks). The terms client and User Equipment may correspond to each other. The term “client” is generally more common for WLAN, whereas User Equipment is the term used in 3G and 3G LTE networks. In either case, such exemplary client can be a laptop, a smart-phone, a PDA, or the like. The client can then have a direct access to the access network instead of being routed through a home network and a gateway. A more efficient data transfer may be the result, as well as a better adaptation to the clients' requirements. The gateway can decide which way (direct or indirect) is favourable in a given situation. Thus, the gateway may have an increased flexibility in planning its resources. The gateway may instruct the client to perform the handover, and/or send a request for handover to the access network. In either case, it is preferable for the client's ID to be communicated to the access network by the gateway.

According to another exemplary embodiment of the present invention, before handover the client accesses to the access network via a gateway, it is possible to determine and/or indicate which gateway connecting the local network and the access network.

According to yet another exemplary embodiment of the present invention, at the gateway, the receipt of information concerning the capability of the client of directly accessing the access network can be performed actively by the client's initiative or in response to a query from the gateway. In other words, information concerning the capability of the client may be transmitted from the client to the gateway.

Thus, appropriate information can be provided based on which a handover may be prepared and carried out. It can be distinguished between client's terminals which are capable of communication directly with the access network, like some mobile phones, “smart phones” or PDAs, as well as laptop computers equipped with WLAN card and modem card for a cellular network on the one hand, and client's terminals which are not capable of communicating directly with the access network, like for example laptops with only a W-LAN adapter on the other hand.

According to still another exemplary embodiment of the present invention, the gateway can obtain from the client a unique identification code in form of a random number and forward that identification code to the access network along with the handover decision, thus allowing the access network to uniquely identify the client and know its former association with the respective gateway.

The random number can facilitate an identification of the client across the entities involved in the handover without the need to reveal its real identity on the access network to the gateway.

According to a further exemplary embodiment of the present invention, at least one out of a group (which group consisting of traffic of the local network, traffic of the access network, channel conditions of the local network and channel condition of the access network) can be observed. The decision for initiating handover can be based on the observation.

Thus, a type of handover may be provided that optimizes the usability of the whole system. A Handover may be avoided into an overloaded cell. Thus by the gateway's decisions whether or not to initiate handover of individual clients to the access network the efficiency and usability of the whole system may be optimized.

According to an additional exemplary embodiment of the present invention, the initiation of the handover can include informing the access network about the handover decision and the identity information of the client, and instructing the client to perform handover.

Thus, the gateway can manage the handover and optimize the data transfer, by enforcing a direct access from the client to the access network.

According to another exemplary embodiment of the present invention, the initiation of the handover can include obtaining from the client possession of measurement data about a quality of signals of one or several base station in the access network.

This allows a more substantiated decision of a handover in order to avoid deterioration due to the handover.

According to still another exemplary embodiment of the present invention, the initiation of the handover can include redirecting data connections from the access network directly to the client, which data connections previously have been routed to the client through the gateway.

According to still further exemplary embodiment, the client can be queried for additional information being relevant for the handover decision.

This facilitates a consideration of further information of the client, for example particular profiles of the client concerning e.g. preferred services, however, such additional information is not limited thereto.

According to another exemplary embodiment, the local network can be a wired local area network and a wireless local area network. However, the group may also include a wireless sensor network, a Zigbee-, Bluetooth- and/or UWB-network. It should be noted that there are also further possibilities, even if not mentioned.

According to another exemplary embodiment, the access network can be a cellular network, a wireless broadband/or access network. The access network can also be a GSM, UMTS or any other mobile communication network.

According to another exemplary embodiment, the client can be a PDA, a laptop, a mobile phone, PC, a wireless mobile music player and/or a computer gaming device, and others.

According to a further exemplary embodiment, a gateway can be provided for handover of a client from a local network to an access network. The gateway can include a first connecting device being adapted for connecting a local network to the gateway, a second connecting device being adapted for connecting an access network to the gateway, a receiving device being adapted for receiving from the client information about the client's ability to connect directly to the access network, which client being connected to the local network, a transmitting device being adapted for transmitting an identification information of the client to the access network and a handover device being adapted to execute handover of the client from the local network to the access network.

For example, with respect to a gateway between, e.g., a WLAN and a cellular network, the gateway may include a radio/communication device that allows it to act as an Access point of the WLAN, a second radio interface that allows it to act as a (e.g., a particular type of) user equipment on the access network and a processing unit that forwards the data between the interfaces, and handles the required communication protocols, manages the communication links, performs handover decisions etc.

According to yet another exemplary embodiment, the handover device can be configured for instructing the client to perform the handover.

According to still another exemplary embodiment, the gateway can also include an observing device being configured for observing at least one of traffic of the local network, traffic of the access network, channel condition of the local network and/or channel condition of the access network. The handover device may be adapted for carrying out executing of handover based on the observations of the observing device. Further, the above observations can also be obtained indirectly by requesting information from the access network or from the client.

According to a further exemplary embodiment, the handover device can be configured for informing the access network about the handover decision and the identity of the client, and instructing the client to perform handover. It is also possible to instruct only the access network to perform the handover. Thus, the gateway would likely should know the real ID of the client on the access network.

According to another exemplary embodiment, the handover device can be configured for obtaining from the client possession of measurement data about a quality of signals of a base station in the access network.

According to yet another exemplary embodiment, a Client can be provided for handover from a local network to an access network. The client can include a first interface configured for connecting a local network, a second interface configured for connection an access network, a transmitting device configured for transmitting information about the client's ability to connect directly to the access network to a gateway, a handover device configured to execute a handover of the client from a connection between the first interface and the local network to a connection between the second interface and the access network.

For example, the client can include a processing arrangement (e.g., a processor) which can have the functionality of the transmitting device and the handover device, and two radio interfaces for acting as client on the WLAN and as UE on the cellular network.

According to a further exemplary embodiment, a program arrangement/computer software can be provided on a computer-readable medium (e.g., any storage device, such as hard drive, RAM, ROM, CD-ROM, removable storage medium, etc.), which, when executed by a processor, can configure the processor to carry out the procedures described herein.

According to an exemplary embodiment of the present invention, the handoff within a hierarchy of networks (e.g., is not performed between two completely separate networks), e.g., from an indirect connection to a direct one, whereas the gateway device has a particular knowledge about both networks and their current status.

The exemplary embodiments of the present invention as described herein, which are described in further detail with reference to the enclosed drawings, are also equally applicable for the method, the gateway and the user equipment, the program element/software arrangement and the computer-readable medium.

Further, the above-described exemplary features may also be combined. The combination of the above features may also lead to synergetic effects, even if not explicitly described in detail.

These and other objects, features and advantages of the present invention will become apparent upon reviewing the following detailed description of embodiments of the present invention.

### BRIEF DESCRIPTION OF THE DRAWINGS

Further objects, features and advantages of the exemplary embodiments of the present invention will become apparent from the following detailed description taken in conjunction with the accompanying figures showing illustrative embodiments of the invention, in which:

FIG. 1 is a communication and interconnection diagram for a gateway, a local network and an access network in accordance with an exemplary embodiment of the present invention;

FIG. 2 is a flow chart of a method according to an exemplary embodiment of the present invention;

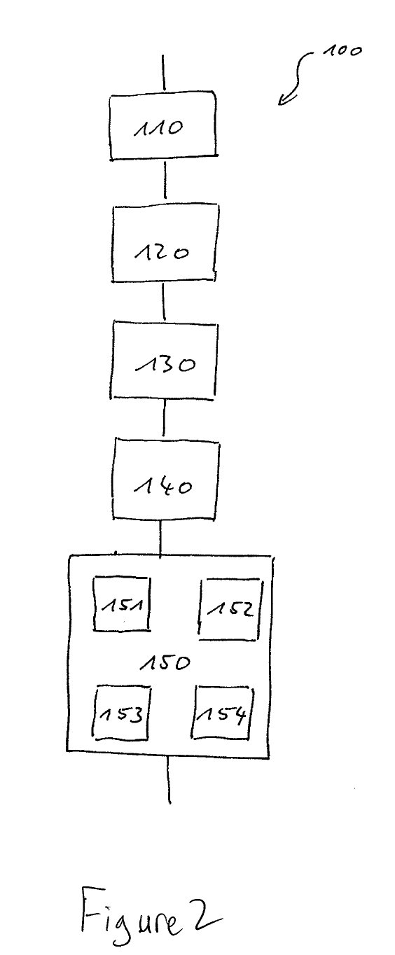

FIG. 3 is a block diagram of a structure of a gateway according to an exemplary embodiment of the present invention; and

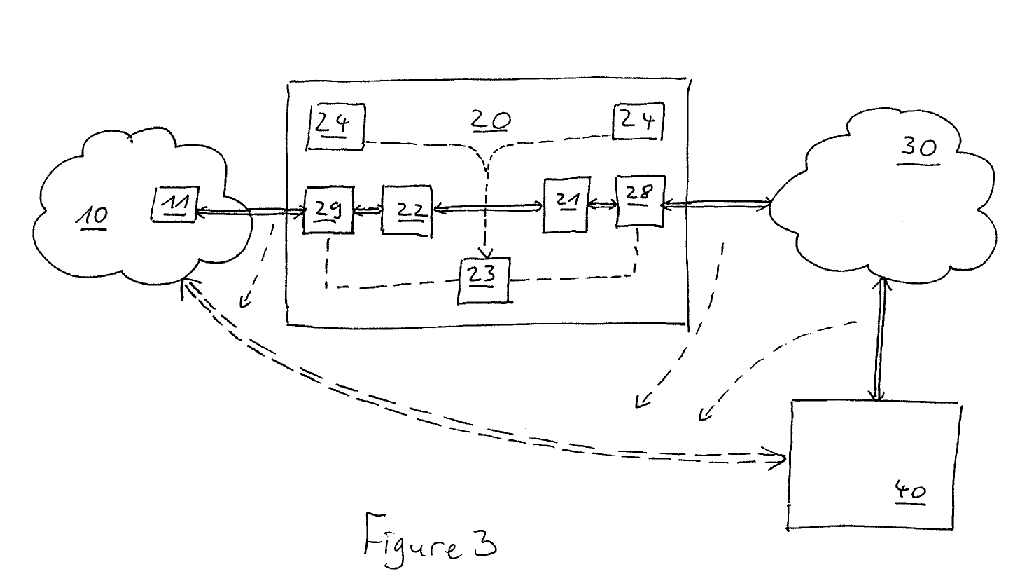

FIG. 4 is a block diagram of the structure of a user equipment which can be implemented according to an exemplary embodiment of the present invention.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention.

### DETAILED DESCRIPTION OF THE DRAWINGS

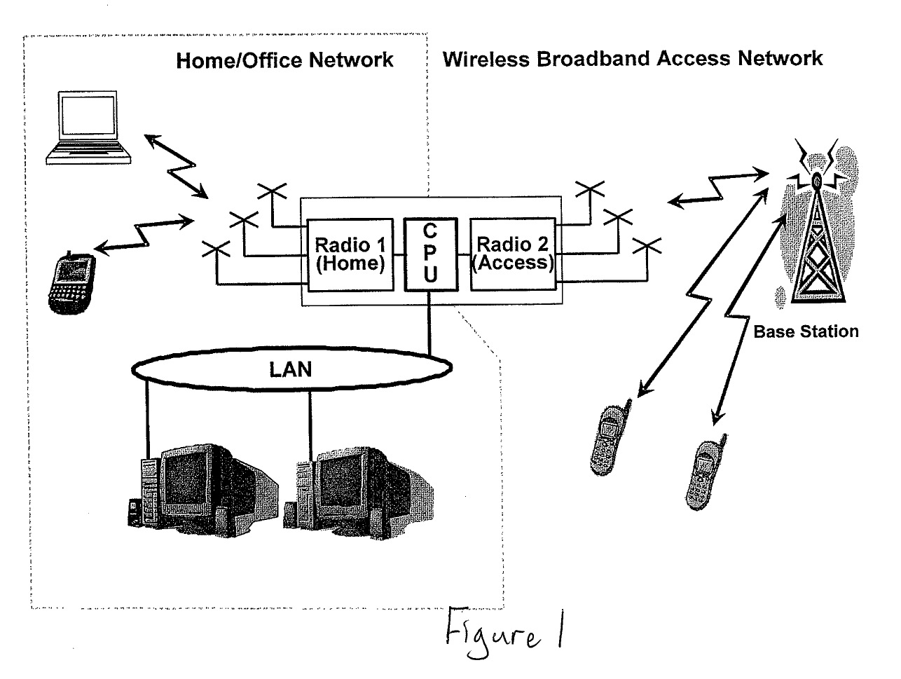

The present invention relates to a concept of the “Home Node,” e.g., a device which is configured to act as a gateway between a local area network, like for example a LAN or a Wireless LAN (WLAN) equipment, and a cellular network or wireless broadband access network, WBA, thus giving clients connected to the LAN/WLAN access to the cellular network, e.g., in order to provide them with Internet access. An exemplary communication and interconnection diagram for a Home Node is depicted in FIG. 1.

With respect to the exemplary description below, it may be assumed that the access network is a cellular network based on the 3G LTE (e.g., long-term evolution) technology. Thus, the term eNodeB (e.g., “evolved NodeB”) is utilized below interchangeably with the term “base station” and the term UE (user equipment) will be used for a client device in the cellular network. The techniques, procedures and systems described herein can surely also be applied to other wireless broadband access (WBA) systems, depending on the underlying technology. The exemplary embodiments of the present invention may, for example, be applicable to WiMAX or WiBro systems as well.

The exemplary embodiments of the present invention can take into consideration that it may be quite common in the future for a client device (e.g., PDA, Laptop, mobile phone, etc.) to have a wireless LAN interface as well as an interface for a cellular or WBA network. The following considerations can assume that the considered clients are connected to the Home Node in a wireless way. However, the exemplary embodiments of the present invention may also be applicable to clients on a wired LAN connected to the Home Node.

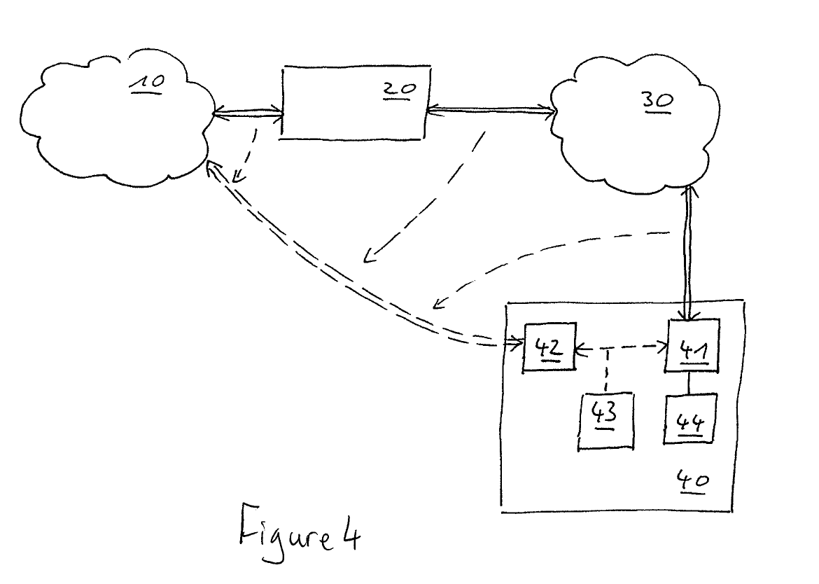

FIG. 4 shows a block diagram of the structure of a user equipment which can be implemented according to an exemplary embodiment of the present invention. For example, as illustrated in FIG. 4, clients 40 connecting to the Home Node or gateway 20 may provide information about their capability of connecting to the access network 10 directly. Therefore, the Home Node 20 is generally aware which of its clients 40 can connect directly to the base station 11 of the access network 10.

The Home Node 20 can initiate a handover based on observation of traffic and channel conditions in its local network 30 and in the access network 10 and possibly on additional information obtained from the access network 10 or the client 40.

The Home Node or gateway 20 may inform the access network 10 about the handover decision and about the identity of the client 40 that will perform the handover. This exemplary procedure can facilitate the access network 10 not only to re-direct the existing data connections accordingly, and also to distinguish the gateway-initiated handover from a handover initiated by the client itself e.g. due to bad link quality between client and Home Node 20.

Optionally, the Home Node or gateway 20 can obtain, from the client, measurement data about the quality of base station signals received by the client 40. The Home Node's base station 11 may not be visible or not be the preferable station from the client's point of view.

According to an exemplary use case, the following procedures may be performed:
The client 40 associates with the Home Node 20 via the WLAN interface 41.
Through a particular protocol (e.g., either upon query by the Home Node or initiated by the client), the client 40 can inform the Home Node 20 or the gateway about its ability to connect directly to the access network 10 and about a unique identifier by which it can be recognized on the access network 10.
At some time after the initial connection setup, the Home Node 20 or the gateway becomes aware that a direct connection of the client 40 to the Access Network 10 would be preferable.

Exemplary reasons for the above-described exemplary procedure can be (but are not limited to):
bad link quality between Home Node and client, e.g. due to large distance or obstacles,
very high traffic load on the local network,
poor channel quality between Home Node and base station in combination with a low traffic load on the base station (according to the Home Node's observation or to reports from the base station)
excellent quality of the direct channel between the client and a base station of the access network (according to a report from the client to the Home Node) in combination with any of the above criteria
The Home Node 20 or gateway may optionally query the client 40 and/or the base station 11 for additional information (e.g. list of base stations visible to the client, . . . )
The Home Node or gateway 20 may directly instruct the client 40 to perform the handover. The Home Node 20 can inform the access network 10 about the handover and about the identity of the client 40 that will be handed over.
The access network 10 may be redirect the data connections previously routed to the client through the Home Node 20 directly to the client 40 which then becomes a UE on the access network 10.
The access network 10 knows that the handover has been initiated by the home node 20 or gateway, which can be used to construct new business models. Examples are provided herein below.

For some of the functionality described above, various alternative implementations are possible.

For example, the exemplary preferable information exchange between Home Node 20 and client 40 can be based on queries issued by the home node to which the client replies on demand or alternatively a client 40 may have to report its capabilities to the Home Node 20 in order to take advantage of the suggested handover scheme. The connection between Home Node 20 and the client 40 can generally be a standard (wireless) LAN connection, so any special information exchange between client and Home Node 20 prefers a (simple) special protocol on top of the standard WLAN protocol. This information exchange may be performed through an IP connection between client and Home Node.

The exemplary embodiments of the present invention may prefer for the Home Node 20 to send certain information to the access network 10 that facilitates the identification of the device 40 that will be handed over. An exemplary implementation can be based on the clients' unique ID for the access network 10. However, from a security and privacy point of view, it may be less preferable for the client 40 to share its true ID with the Home Node. A more preferable solution can be to transmit a sufficiently long random number from the client to the Home Node or gateway 20. The Home Node or gateway 20 can transfer such random key to the access network 10 during handover, and the client 40 may send the same key to the access network 10 so that the access network 10 can map it to the unique ID of the client 40.

A decision of link quality and traffic load on the local network can be performed, for example, by the Home Node or gateway 20 itself. The decision regarding the traffic load on the access network 10 can be performed based on the Home Node's observation of the resource grants sent by the base station 11 and/or by querying the access network 10 for some status information. Thus, the implementation of certain suitable signalling scheme in the standard defining the access network 10 may be preferable.

If the Home Node or gateway 20 knows the true ID of the client 40 on the access network 10, it is not necessary for the Home Node 20 to inform the client 40 directly about the handover decision. It may just inform the access network 10 which can then in turn set up the link to the client 40 and enforce the handover. If only a random key is exchanged between client and Home Node or gateway 20, both the client 40 and the access network 10 should be informed about the handover decision because in this case the client 40 has to initiate the link setup to the base station 11 of the access network 10.

Certain exemplary application examples shall illustrate the usefulness of the described handover concept:

### FIRST EXAMPLE

first operator A can be operating a public WLAN hotspot connected to a cellular Radio Access Network, e.g. a 3G-LTE network operated by a second operator B. This service is offered to the users at a price that is significantly lower than that for an individual direct connection to the access network of operator B. At peak times or if a large number of users connect to the hotspot with relatively bandwidth inefficient equipment (e.g., 802.11b clients on a 802.11g hotspot), the operator may be unable to serve all users according to their needs. It may be more attractive to enforce the handover of some clients to the access network even if operator A has to pay for the higher cost. The user can be charged the rate agreed with operator A irrespective of how the actual data connection is established. Operator A has an agreement with operator B stating that clients handed over form the hotspot would not be billed directly but that operator A would cover the cost. The exemplary model can be beneficial for all parties:

Operator A can satisfy a larger number of users, even at peak times or under conditions where the WLAN radio resources cannot be used efficiently. Operator B may receive additional traffic from users who—due to the higher price—would not normally have chosen to connect directly to the access network. For that additional traffic, operator B can charge operator A at discounted rates. The customer would enjoy good service quality in the hotspot at a reasonable price, even at peak times or if he's located in a remote corner of the hotspot.

### SECOND EXAMPLE

A first operator A is operating an access network (e.g. 3G-LTE) and has to compete with a second operator B who is operating a fixed network. As a special selling point, operator A can offer a special rate for the access from the customer's home. In general, traffic (especially data traffic, Internet etc.) will be directed through the Home Node. However, if for some reason, the Quality of Service QoS may not be guaranteed via this indirect link, e.g., because of too much traffic on the local network, the Home node may initiate the handover of the client to the access network and Operator A will still charge the low rate, whereas for true mobile use, i.e. if the user initiates a connection from some place other than his home, a higher charge would be applied. Thus, the rates in the user's home can be comparable to those of fixed access networks whereas for other locations they will be comparable to other operators' mobile rates. This exemplary model is similar to a popular model (O2 Genion) in Germany where mobile phone users are charged lower rates (comparable to fixed network rates) if they are in a certain “home zone”.

Large companies may sign special contracts with operators of access networks in order to provide high-data-rate coverage throughout their sites. For the main part of the company's premises, access through Home Nodes may be possible, whereas for some remote spots with poor coverage or rare applications with higher data rate requirements direct access to the access network may be granted at a special rate. Users within the range of a Home Node but not belonging to the company cannot benefit from the special rate since they will not be able to access the WLAN, given the usual security measures and access restrictions are applied.

It should be noted that the term ‘comprises’ is not limited to include only the terms and features described in association therein, and does not exclude other elements or steps and the ‘a’ or ‘an’ does not exclude a plurality. Also elements described in association with the different embodiments may be combined. In addition, the reference signs or numerals in the claims shall in no way be construed as limiting the scope of the claims to any exemplary component or device associated with such numerals or reference signs.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. In addition, to the extent that the prior art knowledge has not been explicitly incorporated by reference herein above, it is explicitly being incorporated herein in its entirety. All publications referenced herein above are incorporated herein by reference in their entireties.

What is claimed is:

1. A method for a handover of a client from a local network to an access network, comprising:
receiving, from the client, information associated with an ability of the client to directly connect to the access network, wherein the client is connected to the local network;
transmitting an identification information associated with the client to the access network; and
executing a handover of the client from the local network to the access network.

2. The method according to claim 1, wherein before handover the client accesses to the access network via a gateway, which gateway connecting the local network and the access network.

3. The method according to claim 1, wherein the information concerning a capability of the client of directly accessing the access network is received actively by an initiative of the client or in response to a query from the gateway.

4. The method according to claim 1, wherein the gateway is configured to obtain from the client a unique identification code in form of a random number and forward the identification code and the handover decision to the access network facilitating the access network to uniquely identify the client and recognize a former association of the client with the respective gateway, and facilitating the access network to notice that the handover of the client has been initiated by the respective gateway.

5. The method according to claim 1, further comprising observing at least one a of traffic of the local network, a traffic of the access network, a channel condition of the local network or a channel condition of the access network, wherein the handover is initiated based on the observation.

6. The method according to claim 1, wherein the initiation of the handover includes informing the access network about the handover decision and the identity information of the client, and instructing the client to perform the handover.

7. The method according to claim 1, wherein the initiation of the handover includes obtaining from the client measurement data about a quality of signals of one or more base stations in the access network.

8. The method according to claim 1, wherein the initiation of the handover includes redirecting data connections from the access network directly to the client, wherein data connections are previously routed to the client through the gateway.

9. The method according to claim 1, further comprising querying the client for additional information which is relevant for the handover.

10. The method according to claim 1, wherein the local network is at least one of a wireless sensor network, a Zigbee-, a Bluetooth-network or a UWB-network.

11. The method according to claim 1, wherein the access network is at least one of a cellular network, a wireless network or an access network.

12. The method according to claim 1, wherein the client is at least one of a PDA, a laptop, a mobile phone, PC, a wireless mobile music player or a computer gaming device.

13. A gateway for a handover of a client from a local network to an access network, comprising:
a first connecting arrangement configured to connect a local network to the gateway;
a second connecting arrangement configured to connect the access network to the gateway;
a receiving arrangement configured to receive from the client information regarding an ability of the client to connect directly to the access network, wherein the client is connected to the local network;
a transmitting arrangement configured to transmit a request for handover of the client and an identification information of the client to the access network;
a handover arrangement configured to execute a handover of the client from the local network to the access network.

14. The gateway according to claim 13, wherein the handover arrangement is configured for instructing the client to perform the handover.

15. The gateway according to claim 13, further comprising an observing arrangement configured for observing at least one of a traffic of the local network, a traffic of the access network, a channel condition of the local network or a channel condition of the access network, wherein the handover arrangement is configured execute the handover based on the observations of the observing arrangement.

16. The gateway according to claim 13, wherein the handover device is configured to inform the access network about the handover decision and the identity of the client, and instruct the client to perform handover.

17. The gateway according to claim 13, wherein the handover device is configured to instruct the access network to perform the handover.

18. The gateway according to claim 13, wherein the handover device is configured to obtain from the client measurement data associated with a quality of signals of a base station in the access network.

19. A client for a handover from a local network to an access network, the user equipment comprises:
a first interface arrangement configured to connect a local network;
a second interface arrangement configured to connect the access network;
a transmitting arrangement configured to transmit information associated with an ability of the client to connect directly to the access network to a gateway;
a handover arrangement configured to execute a handover of the client from a connection between the first interface and the local network to a connection between the second interface and the access network.

20. A software arrangement which is provided on a computer readable medium and for a handover of a client from a local network to an access network, which, when executed by a processing arrangement, the software arrangement configures the processing arrangement to execute procedures comprising:
receiving, from the client, information associated with an ability of the client to directly connect to the access network, wherein the client is connected to the local network;
transmitting an identification information associated with the client to the access network; and
executing a handover of the client from the local network to the access network.

21. Computer readable medium having stored a software arrangement for a handover of a client from a local network to an access network, wherein, when executed by a processing arrangement, the software arrangement configures the processing arrangement to execute procedures comprising:
receiving, from the client, information associated with an ability of the client to directly connect to the access network, wherein the client is connected to the local network;
transmitting an identification information associated with the client to the access network; and
executing a handover of the client from the local network to the access network.
